(19) United States
(12) Patent Application Publication
(10) Pub. No.: US 2010/0318409 A1
(43) Pub. Date: Dec. 16, 2010

(54) Component Based Productivity Measurement

(75) Inventors: Lori A. Mayer, South Lyon, MI (US); Miranda L. Mason, Denver, CO (US); Elizabeth C. Klee, Lathrup Village, MI (US)

Correspondence Address: Accenture c/o Murabito, Hao & Barned LLP, Two North Market Street, Third Floor, San Jose, CA, 95113, US

(73) Assignee: Accenture Global Services GmbH, Schaffhausen (CH)

(21) Appl. No.: 12/775,174

(22) Filed: May 6, 2010

Related U.S. Application Data
(60) Provisional application No. 61/186,466, filed on Jun. 12, 2009.

(51) Int. Cl. G06Q 10/00

(52) U.S. Cl. 705/11; 705/348

(57) ABSTRACT

Methods, computer-readable media, and apparatuses evaluate the productivity of a work effort and determine the potential productivity improvement for completing the work effort. The work effort is baselined, and the potential productivity improvement may be assessed by presenting evaluation questions organized by categories. The potential productivity improvement is then applied to an estimating model to obtain an estimated effort for completing the work effort. The actual effort measure is then obtained from a time capture system and compared to the estimated effort in order to generate an indicator that is indicative of the comparison. The baselining of the work effort may be repeated at a subsequent time by obtaining an updated estimated effort from the estimating model and an updated actual effort measure form the time capture system and then comparing them to determine whether the productivity objective has been achieved at the subsequent time.

This application claims priority to U.S. provisional patent application Ser. No. 61/186,466, filed Jun. 12, 2009, entitled “Component Based Productivity Measurement,” hereby incorporated herein by reference as to its entirety.

### BACKGROUND OF THE INVENTION

Productivity may be defined as the amount of output per unit of input (e.g., labor, equipment, and capital). There are many different ways of measuring productivity. For example, in a factory productivity might be measured based on the number of hours it takes to produce a good, while in the service sector productivity might be measured based on the revenue generated by an employee divided by the employee's salary. Productivity may also be applied to high technology, including software design where the productivity may be measured by the lines of tested software code by the total time to design and test the code.

There are typically two ways to promote growth in output: bring additional inputs into production and/or increase productivity. Adding more inputs typically will not increase the income earned per unit of input (unless there are increasing returns to scale) and may result in lower average wages and lower rates of profit. However, productivity growth generates more output and income because the income generated per unit of input increases. Additional resources are also attracted into production and can be profitably employed.

Consequently, productivity growth is an important source that drives the growth in living standards. Productivity growth means that more value is added in production, resulting in more income being available for distribution. The benefits of productivity growth may be distributed in a number of different ways. For example, productivity growth translates to increased competiveness to a business, to better wages and conditions for the workforce, to increased profits for shareholders, to lower prices for customers, and to increased tax revenue for the government.

### SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

With one aspect of the embodiments, the current effort to complete a work effort is baselined, and the potential productivity improvement for completing the work unit is assessed. The potential productivity improvement is then applied to an estimating model to obtain an estimated effort for completing the work effort. The actual effort measure is then obtained and compared to the estimated effort in order to generate an indicator that is indicative of the comparison.

With another aspect of the embodiments, tasks are associated with the work effort, and a portion of the potential productivity improvement is applied to each task.

With another aspect of the embodiments, the potential productivity improvement is assessed by presenting evaluation questions that may be organized by categories so that the potential productivity improvement can be determined from the corresponding answers.

With another aspect of the embodiments, the work effort is partitioned into components, and an amount of effort is estimated for each component.

With another aspect of the embodiments, when a productivity objective has not been achieved, action may be taken (in the form of a continuous improvement initiative) to reduce the effort required to complete the tasks/deliverables and thus, improve productivity.

With another aspect of the embodiments, the baselining of the work effort is repeated after a pre-determined time duration. An updated estimated effort is subsequently obtained from the estimating model, and the updated actual effort measure is obtained from a time capture system. An indicator is generated that is indicative whether the productivity objective has been achieved at the subsequent time based on the updated actual effort measure and the updated estimated effort.

### BRIEF DESCRIPTION OF THE DRAWINGS

The present invention is illustrated by way of example and not limited in the accompanying figures in which like reference numerals indicate similar elements and in which:

FIG. 1 shows a computer system used for assessing productivity measurements in accordance with an embodiment.

FIG. 2 shows a flow diagram for assessing productivity for a work effort in accordance with an embodiment.

FIGS. 3A and 3B show an exemplary assessment of a current productivity level in accordance with an embodiment.

FIG. 4 shows a system for measuring component-based productivity in accordance with an embodiment.

FIGS. 5A and 5B show an example of applying productivity improvements to an estimating model in accordance with an embodiment.

### DETAILED DESCRIPTION OF THE INVENTION

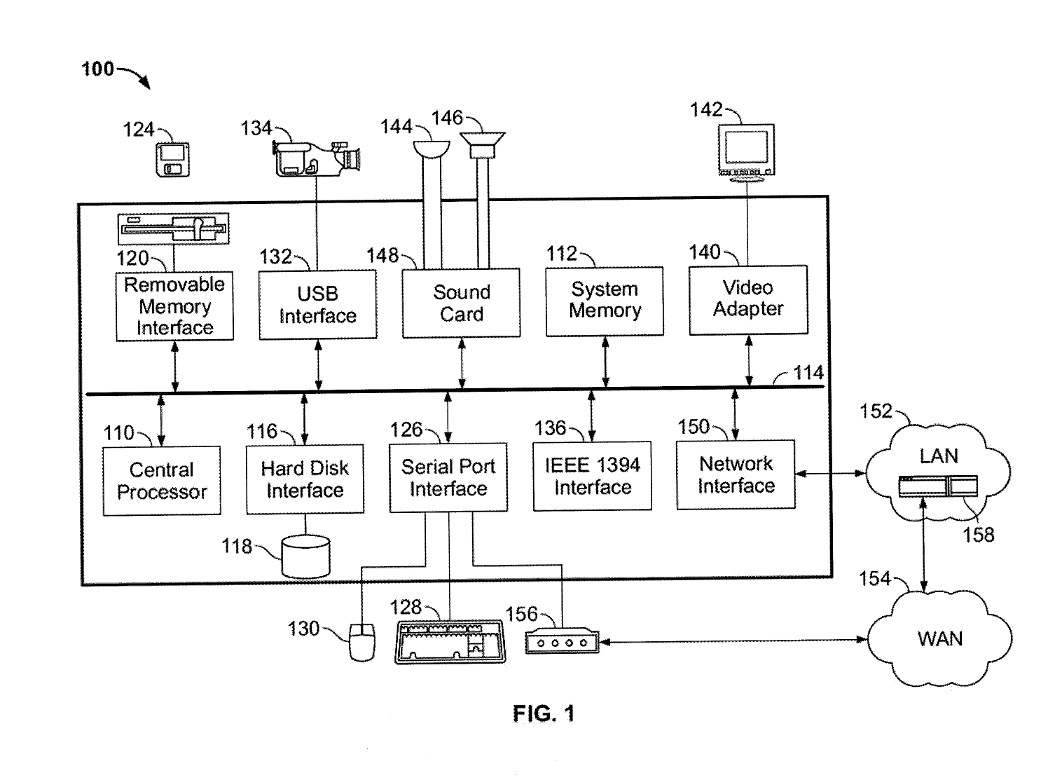

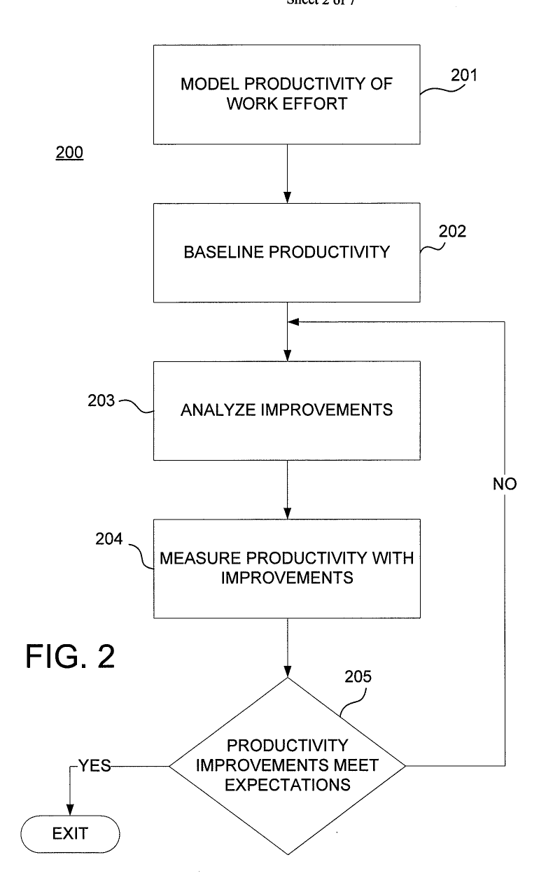

FIG. 1 shows a computer system used in assessing productivity measurements in accordance with an embodiment. Elements of the present invention may be implemented with computer systems, such as the system 100. System 100 may support embodiments as discussed with FIGS. 2-5 and in accordance with aspects for the invention as disclosed herein.

Computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 1 shows a serial port interface 126 coupling a keyboard 128 and a pointing device 130 to system bus 114. Pointing device 128 may be implemented with a mouse, track ball, pen device, or similar device. Of course one or more other input devices (not shown) such as a joystick, game pad, satellite dish, scanner, touch sensitive screen or the like may be connected to computer 100.

Computer 100 may include additional interfaces for connecting devices to system bus 114. FIG. 1 shows a universal serial bus (USB) interface 132 coupling a video or digital camera 134 to system bus 114. An IEEE 1394 interface 136 may be used to couple additional devices to computer 100. Furthermore, interface 136 may configured to operate with particular manufacture interfaces such as FireWire developed by Apple Computer and i.Link developed by Sony. Input devices may also be coupled to system bus 114 through a parallel port, a game port, a PCI board or any other interface used to couple and input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 166. A sound card 148 may be used to couple microphone 144 and speaker 146 to system bus 114. One skilled in the art will appreciate that the device connections shown in FIG. 1 are for illustration purposes only and that several of the peripheral devices could be coupled to system bus 114 via alternative interfaces. For example, video camera 134 could be connected to IEEE 1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, can also be accessed by computer 100. FIG. 1 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 1 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules. Examples of program modules are routines, programs, objects, components, data structures, etc., that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

FIG. 2 shows flow diagram 200 for assessing productivity for a work effort in accordance with an embodiment. The productivity of a work effort is modeled at block 201. The work effort may be modeled using different approaches.

According to an aspect of the embodiments, there are two “output” based measures of productivity where clients need a single measure of productivity. This approach may be implemented with clients, in which productivity commitments or other output based arrangements are a key part of the solution. Output-based productivity approaches include function points and component-based as will be further described.

Output-based productivity refers to the amount of value produced for a given amount of investment. A standard economic definition of productivity is “goods or services produced per unit of labor or expense.” This generally equates to output over input where output is quantified by size and input is quantified by effort.

$$PRODUCTIVITY = \frac{OUTPUT}{INPUT} or \frac{SIZE}{EFFORT} \qquad ( EQ . 1 )$$

Two key components of the above equation are size and effort. Relative to application development and maintenance, size equates to “software size”, measured in terms of function points, for the applications supported (maintenance) and/or the applications delivered (development) or a standard “component” (task) or request type within estimating models that is repeatable over time. Effort equates to the “all-in” cost, in terms of the full-time equivalent (FTE) or hours, for maintaining and/or developing applications.

According to an embodiment, a comprehensive set of metrics is determined on every application outsourcing arrangement that includes the leading indicators of productivity and may be used to demonstrate or approximate productivity and efficiency improvements over time. These metrics may be indicative of reducing operations costs, while simultaneously improving the reliability and quality of delivery and improving service level agreements (SLAB).

According to some embodiments, a full and balanced set of mandatory measures is utilized to drive performance and achieve committed productivity improvements. A comprehensive performance management program consisting of a top to bottom metrics structure may be important for the continuous improvement of utilization, efficiency, quality, reliability and customer satisfaction. Examples of these “levers” or leading indicators of productivity include % On Time Delivery, % On Budget Delivery, Resource Utilization, Requirements Volatility, Defect Rate, Fault Rate, Time Spent on Rework, Resolution Time Performance, Business Volumes (Throughput) delivered over time, and Cancelled Projects.

With some embodiments, the productivity is baselined by measuring the productivity of the work effort at block 202 by utilizing the modeled productivity with a function point approach or a component-based approach.

A function point (FP) measures software size by quantifying the functionality provided to the user based solely on logical design and functional specifications. Standard guidelines for function points are controlled by the International Function Point Users Group (IFPUG) and are defined in the Counting Practices Manual, which is an ISO Standard for Functional Size. Productivity improvements may be demonstrated if the function points delivered per FTE or hour increases over time for development and enhancement activities or if the ratio function points supported per FTE increases over time or remains the same for less cost.

A function point may be defined as a unit of measurement to express the amount of business functionality an information system provides to a user. For example, function points are the units of measure used by the IFPUG Functional Size Measurement Method. The IFPUG FSM Method is an ISO recognized software metric to size an information system based on the functionality that is perceived by the user of the information system and is typically independent of the technology used to implement the information system.

The component-based approach measures the improvement in the time it takes to complete a standard component of work. Task efficiency for application development may be achieved through adjustments or improvements applied to the estimating model(s) defined for the organization. The effort to complete a specific component of work is baselined at the beginning of an arrangement.

For application development, tools may be baselined at the component or task level. The possible improvements to the work effort are analyzed at block 203. For example, efficiency may be achieved through a reduction in the estimate produced by the estimating model(s) year over year. It may be calculated as a percentage reduction in effort over time for a standard, repeatable task or component and calibrated in terms of the adjustments applied to an agreed upon estimating model, where improvements may be introduced as “tighter” adjustments year on year. For example, in year 1 it may take 10 hours to code every widget. Then in year 2, with a 10% productivity improvement commitment, the model may be adjusted to take 9 hours to code every widget. With a 20% improvement commitment, it would be 8 hours for every widget and so on. This method may assume that the work defined by the estimating model(s) is repeatable.

Application maintenance may be measured as an improvement in the time to complete a “component” of work. Components are defined as a Support Requests or Incident Completed and may be calculated as Number of Support Requests Completed/Hour. This method may assume that there is a relatively fixed application portfolio (i.e., no significant additions or retirements year on year).

The component-based approach may be used when the primary objective is to show improvement over time. Component-based productivity measurement may be used without the need to count function points. The component-based approach is typically easier to implement and maintain as compared to function points; however, it may involve incremental effort to baseline, maintain, and track over time. It may result in many of the benefits of function points but with less cost. However, component-based measurement is not typically used to compare an organization's performance to the industry. The approach is slightly different across maintenance and development as the definition of “component” is different for each type of work.

Function points are an industry standard approach with international guidelines for usage (IFPUG). It may infuse objectivity into the information technology (IT) vendor management process and typically works well for both development and maintenance. If it is desired to benchmark performance across industry over time, then function points should be used. Disadvantages associated with the function point approach may include a more intensive up front and ongoing effort, with associated costs. Some system elements are less conducive to accurate function point counting so exclusions and alternative approaches should be agreed up front with the client.

To define the initial application development productivity task baseline, a formal baseline may be completed within an agreed timeframe after commencement date, typically 12 months. This baseline may serve as the basis from which to measure all future improvements to development tasks. Once the baseline is completed, future client application development and enhancement work may be measured against these baseline values.

With some embodiments, the baselining process for development consists of baselining the estimating models specific for the client's mix of work, as well as baselining the total number of hours spent on development activities. As part of this process, separate estimating models based on technology and project size may be selected. Examples of estimating models include large application development, small application development, SAP, or 2-N implementations. Within the estimating models, the specific repeatable tasks or deliverables are also defined, accounting for varying complexity levels for each task/deliverable. The effort (hours) required to complete each task/deliverable defined in the estimating model is determined, and the estimating models are baselined. Ideally a baseline represents the client's performance just prior to the contract effective date. However, this approach typically requires rigor in time tracking and project documentation so that the hours required to complete each task/deliverable based on the historical performance of the client's projects can be determined. If this is not the case, the baseline may begin at the start of the contract effective date using tools and methodologies.

Once the estimating model baseline is completed, the agreed productivity improvements may be applied to estimating models each year through reducing the overall estimate produced by the estimating model by the amount of the productivity improvement expected. For example, if the productivity commitment is 10% for the year, the overall estimate produced by the estimating model is reduced by 10%. This does not mean that the effort estimated for each individual task/deliverable must be reduced the same amount, but rather that the reductions to each individual task/deliverable may be higher or lower than the productivity improvement expected as long as the overall model produces an estimate equal to the productivity improvement expected.

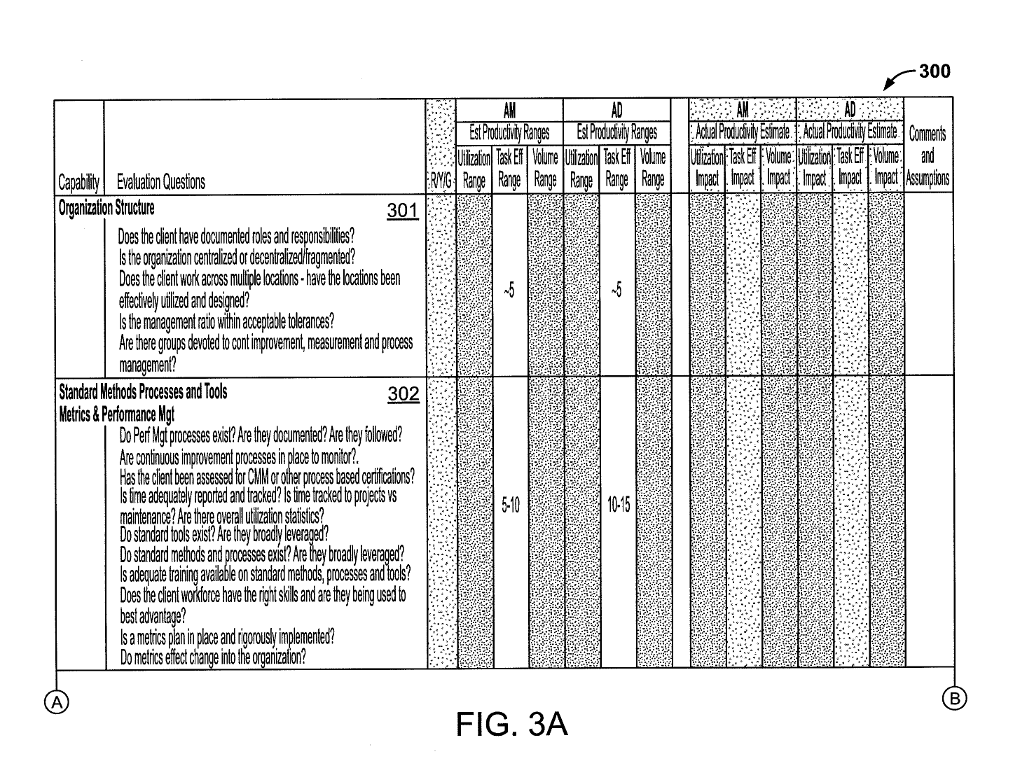

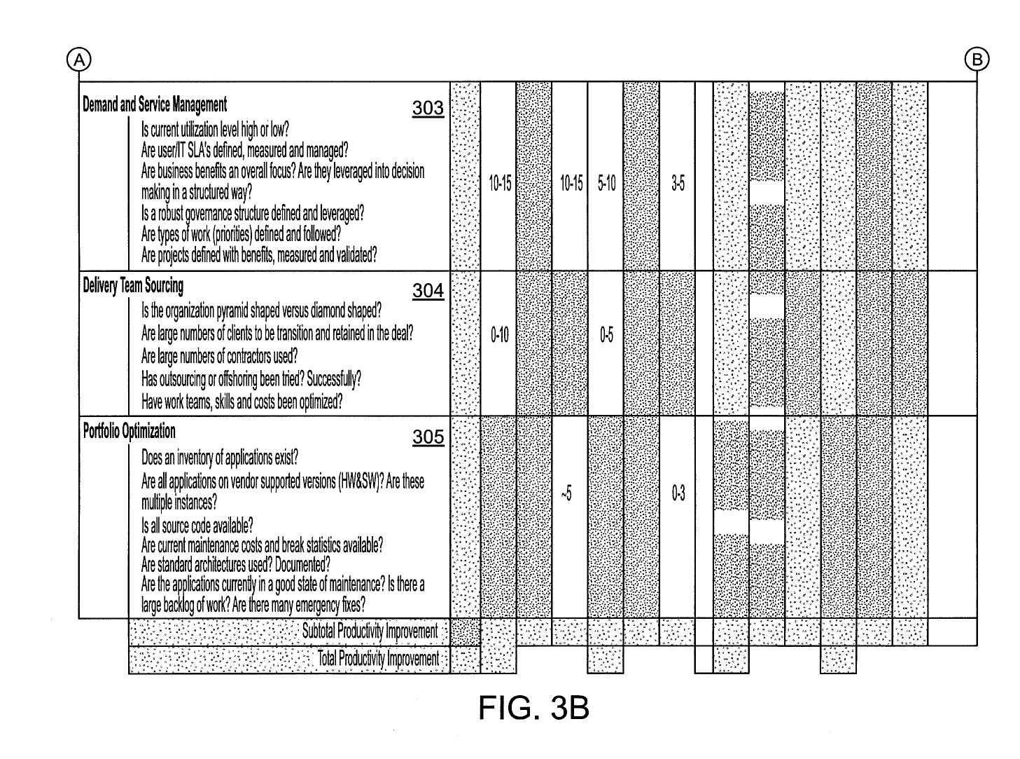

When the productivity improvements have been applied to the estimating model, the corresponding actual productivity is measured at block 204 using the productivity model as previously discussed. If block 205 determines that productivity improvements have not been achieved in accordance with productivity assessment tool (e.g., spreadsheet 300 as shown in FIGS. 3A and 3B), action may be taken (in the form of a continuous improvement initiative) to reduce the effort required to complete the tasks/deliverables and thus, improvement productivity. Blocks 203 and 204 may be repeated to re-assess the productivity improvements.

If productivity is not achieved, reassessing may not improve productivity. Action may be taken to reduce the effort to complete the tasks/deliverables specified in the estimating model to generate the expected productivity improvement. These initiatives to improve productivity may require a formal continuous improvement project to be launched.

Application maintenance productivity for the client may be calculated as the Total Number of Incidents or Support Requests Completed per Hour. To define the initial application maintenance productivity value, a formal baseline may be completed within an agreed timeframe after commencement date, typically 6-8 months depending on the number of in scope applications and incident volumes. This baseline may serve as the basis from which to measure future improvement. This baseline may consist of the total number of support request types by category and total support hours by application, support request type, and in total.

The measurement categories may be segmented based on service level and application technology. Categories and components should be defined in the baseline and measured consistently over time.

As an alternative to measuring productivity using a component-based productivity measurement approach, application development and enhancement productivity for the client may be calculated as a ratio of Function Points Delivered per Person Month. To define the initial application development productivity value, a formal baseline may be completed within an agreed timeframe after commencement date, typically 12 months. This baseline may serve as the basis from which to measure all future improvement. Once the baseline is completed, future client application development and enhancement work may be measured against these baseline values.

Development and enhancement productivity baselines may be created. For example, the baseline may consist of at least 30 historical projects per category of work to enable a statistically valid sample set. The baseline projects should be representative (in both scope and size) of the work that will be performed for the client going forward.

The baseline analysis may assist a client to determine whether more than one development productivity category needs to be defined. Exemplary results suggest that development productivity ratios may vary significantly based on technology (in the case of the Client, Java/J2EE, web technology and data warehouse), and project size. For example, exemplary results, as well as the industry rates from organizations such as Gartner and David Consulting Group, have shown that function point counts per person month (FP/PM) may vary widely (i.e., 8 FP/PM for data warehouse development, 16 FP/PM for Java development, and 23 FP/PM for web development). This may have a material impact on the baseline if the type of work varies during the engagement.

Exemplary results have shown that very large projects (over 500 hours) or small enhancement activities (under 40 hours) have a lesser degree of productivity and therefore may result in the need for additional productivity categories to measure this work independently. Changes in the type and the amount of work in these areas may need to be taken into account to determine if future baseline adjustments are needed.

Once the baseline is completed, future client development projects and enhancement activities may be counted using FPs. FPs are generally counted at two points during the project lifecycle for each project/enhancement: (1) estimate: when requirements are finalized and (2) final: once deployment has begun. Counting FPs, when the requirements are finalized, may ensure that the development productivity is understood early in the project lifecycle. The final FP count performed during deployment may ensure that any changes to requirements are considered in the final application development productivity calculation.

Function point counts used in client calculations may be performed in accordance with the most recent version of the IFPUG Counting Practices Manual to perform the FP counts. A Value Adjustment Factor (VAF) may also be calculated based on the fourteen General System Characteristics (GSC) as defined in the IFPUG Counting Practices Manual. The VAF will be used to calculate the adjusted FP count. All assumptions used to calculate the FP count and the VAF may be formally documented in a standard FP counting template tailored to meet the client's requirements. The adjusted FP counts may be used in conjunction will the respective Person Hours to calculate the Development Productivity Ratio defined as Function Points Delivered per Person Hour.

Based on exemplary results, certain projects may not suitable for function points (i.e., infrastructure upgrades and re-hosting projects which don't deliver any specific end user functionality for the effort expended). As a result, these projects are typically excluded from function point analysis. At the beginning of the baselining period, work with the client determines which projects should be considered for exclusion. Application of all exclusions may then be consistent with the baseline and future productivity measurement to enable a fair comparison and accurate productivity reporting to the client.

Application maintenance productivity for the client may be calculated as a ratio of Function Points Supported per Person Month. To define the initial application maintenance productivity value, a formal baseline may be completed within an agreed timeframe after commencement date, typically 6-8 months depending on the number of in scope applications. This baseline may serve as the basis from which to measure all future improvement. Once the baseline is completed, the baseline may consist of function point sizing and required support FTEs by application and in total.

All future additions, changes or deletions (through application retirements) to the functionality supported in the application portfolio may result in respective adjustments to the baseline application portfolio function point counts. If the function point count changes over time, any material changes to the scope, size or complexity of application portfolio over time may result in the adjustment to the FP count and potentially alter the complexity rating of the application.

Exemplary results indicate that traditional IFPUG FP counting methods may be cost prohibitive for sizing a large application portfolio. Consequently, it may be advantageous to use an approximation technique to determine the FPs for each application in the client portfolio. Approximation may use one of a variety of sizing methodologies to calculate the FPs for each application based on inputs.

Different industry standard approximation techniques include (but are not limited to) (1) IFPUG Lite and (2) “Indicative Method.” Some embodiments may use the IFPUG Lite approach in combination with full IFPUG counts as appropriate for critical applications. The benefits and trade-offs of these two approximation techniques are as follows:

IFPUG Lite: An estimated function point count is completed by evaluating all functions of all function types (ILF, EIF, EI, EO, EQ) using a proprietary automated tool to calculate the function count. The rate of complexity of every data function (ILF, EIF) is set as Low and of every transactional function (EI, EO, EQ) is set as Average. This method has a lower level of accuracy (+/−25%) but also a lower cost compared to a full IFPUG Function Point count (generally ½ week per application on average, which is approximately half the effort to perform a full function point count).
Indicative Method: An indicative function point count is completed by determining the number of data functions (ILFs and EIFs) and calculating the total function point count as 35× number of ILFs+15× number of EIFs. This count is based on the assumption that there will be about three EIs (to add, change, and delete information in the ILF), two EOs, and one EQ on average for every ILF, and about one EO and one EQ for every EIF. This method has a lower level of accuracy (+/−50-100%) and a lower cost (¼-½ day per application).

Because these methods are approximating FPs, each method carries a slight degree of variability when compared to traditional FP sizing methods. However, this small variance may be acceptable given the significantly lower cost to the client and a shorter timeframe for determining functional size verses the traditional IFPUG counting method.

FIGS. 3A and 3B show exemplary assessment tool 300 of a current productivity level in accordance with an embodiment. Productivity assessment tool 300 may assist a certified Solution Architect (SA) in working through a structured approach in order to estimate the expected productivity improvements for the development and or maintenance of a portfolio of applications. Tool 300 may provide an internal guide to help SA's estimate productivity improvement.

With some embodiments, assessment tool 300 calculates the potential productivity improvement percentage for both application development and maintenance work. Productivity assessment tool 300 may provide a standard, methodical way of evaluating the levers which are known to have the greatest impact on productivity. Tool 300 may guide the user through a series of questions about the existing and desired organization, methods/processes/tools, demand and service management function, delivery team sourcing and portfolio optimization opportunities to evaluate where the potential for improvement exists. For each question the potential productivity improvement percentage is documented. Tool 300 then aggregates across all questions to produce an overall potential productivity improvement percentage for both application development and application maintenance. This percentage may be used to calculate the percentage by which the estimating model tasks/components may be reduced. To achieve the calculated productivity improvement, action may be instituted to initiate and complete improvement initiatives which drive the expected productivity improvement.

With step 1, the data collection process is reviewed as allowed by the procurement process or the corresponding time frame.

In step 2, based on the information gathered, tool 300 assesses each question as Red, Yellow, or Green in each of the categories 301-305 listed on the assessment tab using the following exemplary criteria: Red—Not aware of X/Aware but undocumented and unenforced, Yellow—Documented but not enforced/Inconsistently enforced, and Green—Consistently enforced. For example, the question “Do you have a continuous improvement process for application management processes?” may be assessed as: Red—No, we don't have one/We periodically adopt productivity improvement practices but it never sticks, Yellow—We have a process but don't really follow it/We have a process and some groups follow it, or Green—We have a formal process from which we periodically report on the progress of the organization.

While answers to questions may be associated with different colors (e.g., Red, Yellow, or Green), some embodiments may use other input characteristics (e.g., input indicia) to obtain answers to assessment questions.

In step 3, for those areas in which there was not enough information, assumptions are made and documented.

In step 4, based on the reference ranges (e.g., columns D thru I of spreadsheet 300) as shown in the spreadsheet in FIGS. 3A and 3B, a productivity improvement percentage for the capability is determined. Estimated productivity improvements are provided for reference in the “Est Productivity Ranges” and may be based on past experience with potential improvement that can be expected for each category 301-305. Expected productivity improvement ranges may be documented in the “Actual Productivity Estimate” columns and indicate the expected improvement for categories 301-305 based on expert assessment by the Solution Architect through evaluation of the answers to the questions for each category 301-305.

With some embodiments, partial productivity improvements may be recommended when only some of the questions in categories 301-305 are affirmatively answered.

In step 5, the productivity improvements to lines 33-38 (referring to the spreadsheet in FIGS. 3A and 3B) are summed.

In step 6, the total productivity improvement ranges against known and unknown data are reviewed and updated as appropriate.

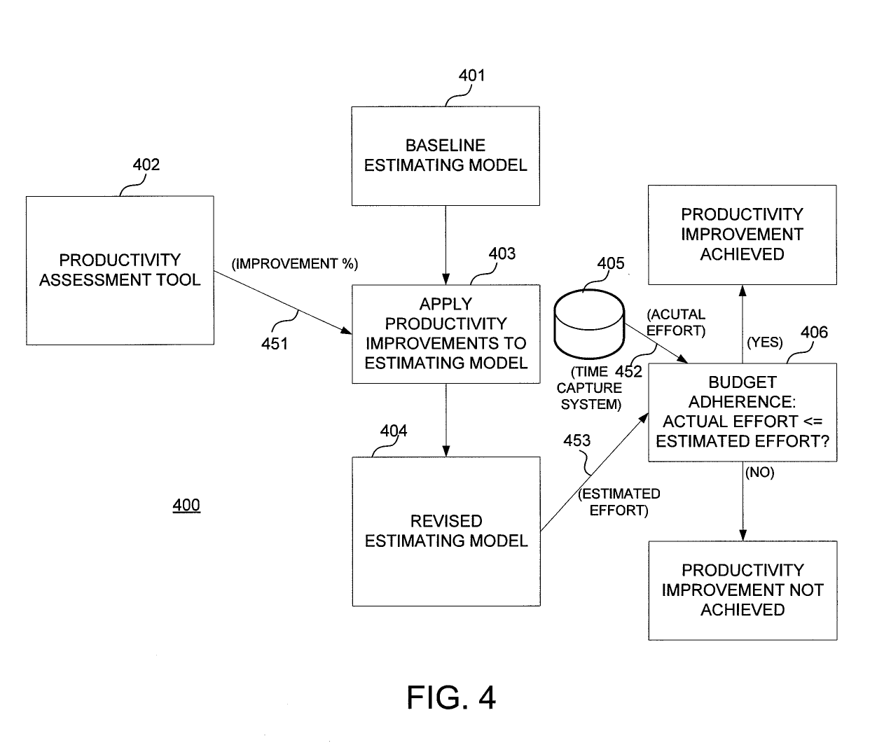

As will be discussed, the projected productivity improvements provided by tool 300 may then be applied as a productivity improvement to the estimating model(s) as noted in FIG. 4 as item 451.

FIG. 4 shows system 400 for measuring component-based productivity in accordance with an embodiment. System 400 may assume different forms, including a processing environment provided by computer 100 as shown in FIG. 1. However, some embodiments may use other approaches for measuring the productivity of a work effort.

The productivity of a work effort is modeled by estimating model 401 using a productivity measurement approach. For example, with some embodiments the component-based productivity measurement approach measures the improvement in task efficiency: “doing the same work with less effort over time”. For application development, task efficiency may be realized through a reduction in the effort it takes to complete a standard component of work (as defined through a standard estimating model). Estimating models may use input parameters such as system complexity, scope and scale to calculate the overall estimated effort to complete the work.

With some embodiments, the component-based productivity measurement approach may be a reasonable alternative to an output based productivity model using function points.

The component-based productivity measurement approach may be used when the primary objective is to show internal improvement over time and when external benchmarking of productivity results is not required. While the component-based approach may not require the lengthy task of counting of function points (often the industry standard method for sizing software), it does involve some incremental effort to baseline, maintain, and track improvements over time.

If there is a business need to compare an organization's performance to the industry, an output based model using function points may be more appropriate as most industry benchmarks are typically stated as hours (or cost) per function point. However, the component-based model may provide a reasonable, low cost option for measuring internal improvement.

As previously discussed, productivity assessment tool 402 (corresponding to tool 300 in FIGS. 3A and 3B) estimates productivity improvements 451 that may be achieved in accordance to answers to different categories of questions. Consequently, tool 402 provides an estimate of a productivity improvement (e.g., expressed in a percentage of the total effort). To obtain revised estimating model 404, the productivity improvement may then be distributed over the components (tasks) by process 403 so that the sum of the distributed improvements approximately equals the estimated productivity improvement provided by tool 402.

Productivity improvements may then be applied at the task/component level as a reduction in the estimated effort to complete that task/component. However, productivity improvements may be calculated at the aggregate level (e.g., by evaluating the overall estimated effort produced by the estimating model). For example, if the baseline indicates that the work effort requires 1,000 hours to complete a standard, the estimating model is adjusted (at the task/component level) to produce an overall estimate of 900 hours, corresponding to a 10% improvement in productivity. With this example, the 10% improvement may not be applied universally to every task/deliverable. Some may receive a higher percentage and some a lower percentage, but the aggregate improvement should total 10%. For example, if there are 10 tasks which total 100 hours and a 10% productivity improvement is expected, the resulting effort (after the estimating model is revised) should total 90 hours. The 10 hour reduction may be achieved by reducing the effort for one or more tasks/deliverables, but it may not be necessary to reduce each task specifically by 1 hour.

The estimated work effort 453 provided by revised productivity model 404 may be compared by process 406 with actual work effort 452 based on actual times captured by database 405. If the actual effort is less than or equal to the estimated effort, then the productivity improvement has been achieved. With some embodiments, if the improvement has not been achieved, productivity assessment tool 402 may be refined to re-assess the estimated productivity improvement or improvement initiatives may need to be executed to further improve productivity and achieve the expected improvement percentage. Processes 406 may then be repeated to determine whether the revised productivity improvement has been achieved. With other embodiments, if the productivity objective has not been achieved, the productivity improvement may be distributed differently among the plurality of tasks.

While the estimating model may be calibrated to produce a lower effort estimate, true productivity improvement may be achieved only if the work can be performed at or under the lower effort estimate. To enable this, the component-based model should be implemented in conjunction with a budget adherence metric to ensure lower budgets are being achieved. For example, if one reduces the effort estimate 453 produced by estimating model 404 by 10%, but actual effort 452 is consistently 15% over estimated effort 453, then one has not achieved any productivity improvement and the productivity has in fact declined by 15%. On the contrary, if actual effort 452 is consistently 10% under estimated effort 453, then one has realized a 20% productivity improvement.

The baseline over time should be maintained as the activities required to complete the work change or as any other factors change that may have an impact on the effort required to complete the work. This helps to ensure that the work being measured going forward is consistent with that defined in the baseline to enable a fair evaluation of the productivity improvement realized over time.

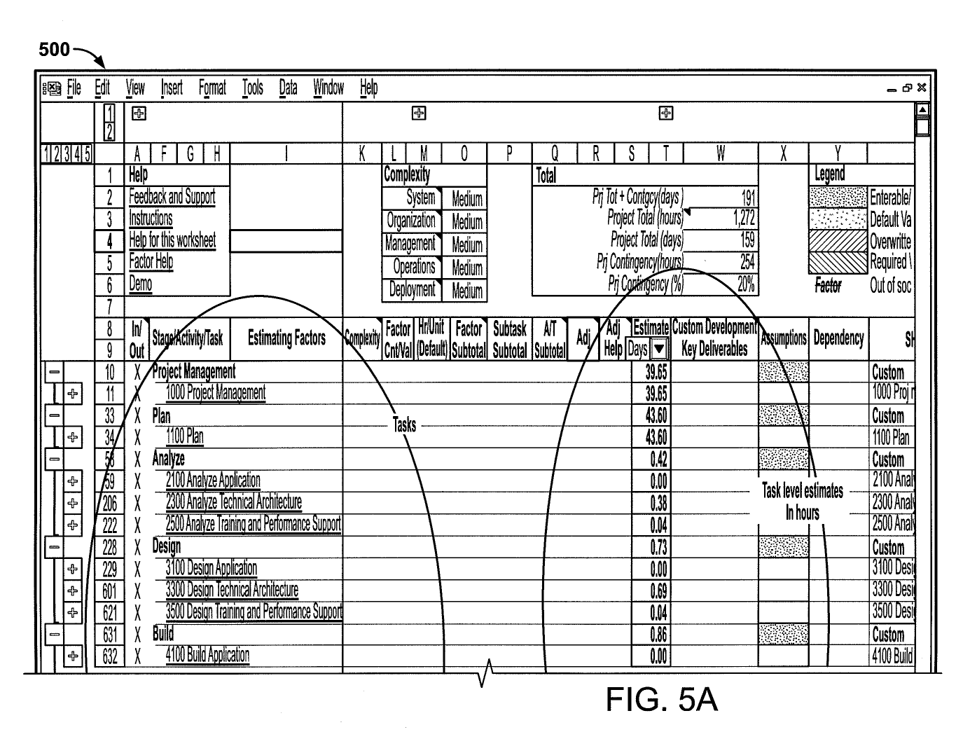

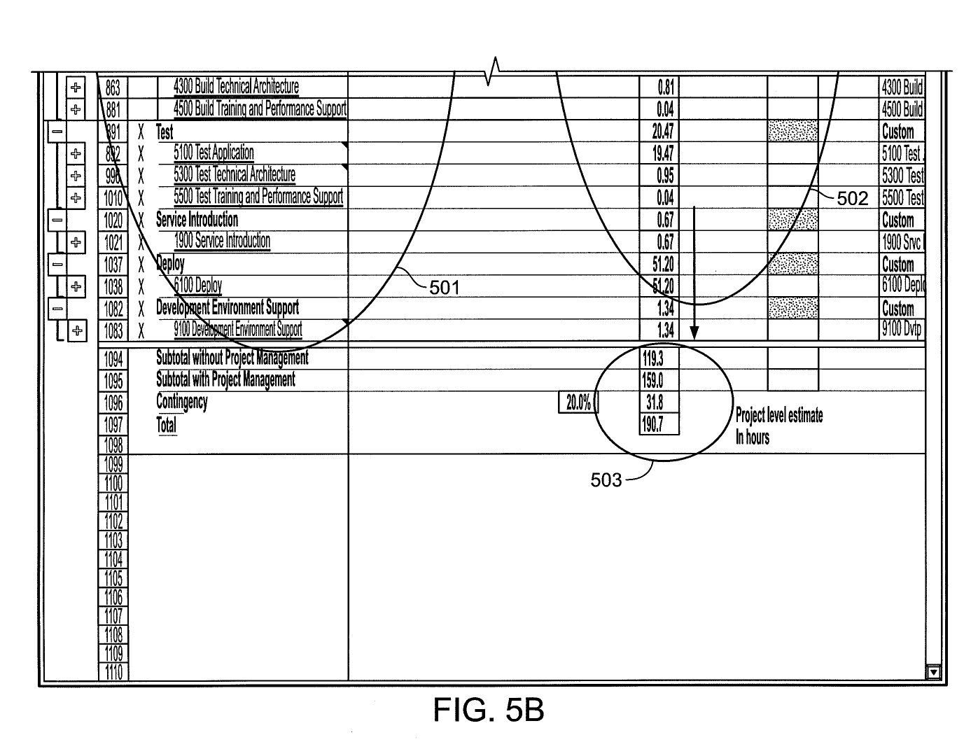

FIGS. 5A and 5B show an example of applying productivity improvements to estimating model 500 in accordance with an embodiment. Task level estimates 502 for tasks (components) 501 are reduced so that the overall reduction at the project level approximately equals the productivity commitment. For example, if the productivity commitment were 10% for the year, then revised project level estimate 503 should be 10% less after the task level estimates are reduced. This does not require each task/deliverable to be reduced by 10%. Some reductions will be higher and some will be lower, but on aggregate the estimate produced by the model must equal 10%.

As can be appreciated by one skilled in the art, a computer system with an associated computer-readable medium containing instructions for controlling the computer system may be utilized to implement the exemplary embodiments that are disclosed herein. The computer system may include at least one computer such as a microprocessor, a cluster of microprocessors, a mainframe, and networked workstations.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A computerized method comprising:
baselining, by a computer system, a current effort to complete a repeatable unit of work;
assessing, by the computer system, a potential productivity improvement for completing the repeatable unit of work;
applying, by the computer system, the potential productivity improvement to an estimating model to obtain an estimated effort for completing the repeatable unit of work;
obtaining, by the computer system, an actual effort measure to complete the repeatable unit of work; and
generating, by the computer system, an indicator whether a productivity objective has been achieved from the actual effort measure and the estimated effort.

2. The method of claim 1, wherein:
a plurality of tasks are associated with the repeatable unit of work; and
the applying comprises applying a portion of the potential productivity improvement to each of the plurality of tasks.

3. The method of claim 1, wherein the assessing comprises:
presenting a plurality of evaluation questions;
obtaining corresponding answers to the plurality of evaluation questions; and
determining the potential productivity improvement from the corresponding answers.

4. The method of claim 3, wherein the plurality of questions are partitioned into a plurality of categories.

5. The method of claim 4, the method further comprising:
associating a portion of the potential productivity improvement to each category.

6. The method of claim 2, further comprising:
when the indicator is indicative that the productivity objective has not been achieved, taking action to further improve productivity to meet expected improvement targets.

7. The method of claim 1, further comprising:
partitioning the repeatable unit of work into a plurality of components; and
estimating an amount of effort for each component.

8. The method of claim 1, further comprising:
when the productivity objective has not been achieved, taking action to further improve productivity to meet expected improvement targets; and
reevaluating if the expected productivity improvement has been achieved.

9. The method of claim 1, wherein the obtaining comprises:
accessing the actual effort measure from a time capture system.

10. The method of claim 1, further comprising:
after a pre-determined time duration, repeating the baselining of the repeatable unit of work;
applying, by the computer system, the potential productivity improvement to an updated estimating model to obtain an updated estimated effort for the repeatable unit of work;
obtaining, by the computer system, an updated actual effort measure to complete the repeatable unit of work; and
generating, by the computer system, an updated indicator whether the productivity objective has been achieved from the updated actual effort measure and the updated estimated effort.

11. A computer-readable storage medium storing computer-executable instructions, when executed, cause a processor to perform a method comprising:
baselining a current effort to complete a work effort;
assessing a potential productivity improvement for completing the work effort;
applying the potential productivity improvement to an estimating model to obtain an estimated effort for completing the work effort;
accessing an actual effort measure to complete the work effort;
determining whether a productivity objective has been achieved from the actual effort measure and the estimated effort; and
when the productivity objective has not been achieved, taking action to further improve productivity to meet expected improvement targets.

12. The computer-readable medium of claim 11, said method further comprising:
applying a portion of the potential productivity improvement to one of a plurality of tasks, wherein the plurality of tasks are associated with the work effort.

13. The computer-readable medium of claim 11, said method further comprising:
presenting a plurality of evaluation questions;
obtaining corresponding answers to the plurality of evaluation questions; and
determining the potential productivity improvement from the corresponding answers.

14. The computer-readable medium of claim 12, said method further comprising:
when the productivity objective has not been achieved, distributing the potential productivity improvement differently among the plurality of tasks.

15. The computer-readable medium of claim 11, said method further comprising:
partitioning the work effort into a plurality of components; and
estimating an amount of effort for each component.

16. The computer-readable medium of claim 11, said method further comprising:
after a pre-determined time duration, repeating the baselining of the work effort;
applying the potential productivity improvement to an updated estimating model to obtain an updated estimated effort for the work load;
obtaining an updated actual effort measure to complete the work load; and
generating an updated indicator whether the productivity objective has been achieved from the updated actual effort measure and the updated estimated effort.

17. An apparatus comprising:
at least one memory; and
at least one processor coupled to the at least one memory and configured to perform, based on instructions stored in the at least one memory:
baselining a current effort to complete a work effort;
assessing a potential productivity improvement for completing the work effort;
applying the potential productivity improvement to an estimating model to obtain an estimated effort for completing the work effort;
obtaining an actual effort measure to complete the work effort; and
generating an indicator whether a productivity objective has been achieved from the actual effort measure and the estimated effort.

18. The apparatus of claim 17, wherein the at least one processor is further configured to perform:
applying a portion of the potential productivity improvement to one of a plurality of tasks, wherein the plurality of tasks is associated with the work effort.

19. The apparatus of claim 17, wherein the at least one processor is further configured to perform:
presenting a plurality of evaluation questions;
obtaining corresponding answers to the plurality of evaluation questions; and
determining the potential productivity improvement from the corresponding answers.

20. The apparatus of claim 18, wherein the at least one processor is further configured to perform:
when the indicator is indicative that the productivity objective has not been achieved, distributing the potential productivity improvement differently among the plurality of tasks.

21. The apparatus of claim 17, wherein the at least one processor is further configured to perform:
when the productivity objective has not been achieved, revising the potential productivity improvement; and
applying the revised productivity improvement to the estimating model.

22. The apparatus of claim 17, further comprising:
a time capture system,
wherein the at least one processor is further configured to perform:
accessing the actual effort measure from the time capture system.

23. The apparatus of claim 17, wherein the at least one processor is further configured to perform:
after a pre-determined time duration, repeating the baselining of the work effort;
applying the potential productivity improvement to an updated estimating model to obtain an updated estimated effort for the work effort;
obtaining an updated actual effort measure to complete the work effort; and
generating an updated indicator whether the productivity objective has been achieved from the updated actual effort measure and the updated estimated effort.
